(19) United States
(12) Patent Application Publication
(10) Pub. No.: US 2018/0052340 A1
(43) Pub. Date: Feb. 22, 2018

(54) POSITIONER AND POSITIONING EQUIPMENT

(71) Applicants: BOE TECHNOLOGY GROUP CO., LTD., Beijing (CN); BEIJING BOE DISPLAY TECHNOLOGY CO., LTD., Beijing (CN)

(72) Inventors: Qi Chen, Beijing (CN); Lizhu Yu, Beijing (CN); Peng Di, Beijing (CN); Shuo Chen, Beijing (CN); Zhixin Wu, Beijing (CN)

(21) Appl. No.: 15/660,931

(22) Filed: Jul. 26, 2017

(30) Foreign Application Priority Data
Aug. 17, 2016 (CN) 201620895753.8

(51) Int. Cl. G02F 1/13; B65G 47/24

(52) U.S. Cl. CPC G02F 1/1303; G02F 1/133528; B65G 47/24

(57) ABSTRACT

The present disclosure relates to a positioner and positioning equipment, and relates to the field of display technology. The positioner includes a bottom face and a first side face which are perpendicular and adjacent to each other, the first side face being configured to abut against a work piece to be positioned so as to position the work piece to be positioned, the bottom face being provided with a magnetic member.

### CROSS-REFERENCE TO RELATED APPLICATION

This application claims the benefit of Chinese Patent Application 201620895753.8 filed on Aug. 17, 2016 in the State Intellectual Property Office of China, the whole disclosure of which is incorporated herein by reference.

### TECHNICAL FIELD

The present disclosure relates to a field of the display technology, especially to a positioner and positioning equipment.

### DESCRIPTION OF THE RELATED ART

In the field of display technology, the LCD (Liquid Crystal Display) display has the characteristics of a small size, a low power consumption and a low manufacturing cost, which gradually dominates the display market.

For LCD displays, attaching a polarizer is an indispensable step. In the production process, it is necessary to perform a positioning operation to the polarizer, regardless of whether equipment runs automatically, or the staff implements an operation of placing or removing a polarizer.

However, as for a positioner in the prior art, before placing the polarizer, it is required to release the two first screws and the two second screws of the conventional positioner one by one, and slide them along the grooves to the edge, and then place the polarizer, and slide the positioner along the groove to the edge of the polarizer, and then tighten the four screws respectively to position the polarizer. As the structure of the conventional positioner is complicated, operations of the positioner are cumbersome, and the screws are frequently slipped or deformed. On a basis of this, the screw is of a linear structure, resulting in that the screw is not perpendicular to a bottom of the screw if the screw is deformed in the process of fastening the screw or screws and nuts are loosen. Therefore, the polarizer can be damaged when the polarizer is taken out.

### SUMMARY

An embodiment of the present disclosure provides a positioner and positioning equipment. The positioner has a simple structure, an operation process which is easy, and damage to the edge of the polarizer will be avoided when the polarizer is taken out.

In order to achieve the above object, the embodiments of the present disclosure employ the following technical solutions:

According to an aspect of the present disclosure, there is provided a positioner comprising a bottom face and a first side face which are perpendicular and adjacent to each other, the first side face being configured to abut against a work piece to be positioned so as to position the work piece to be positioned, the bottom face being provided with a magnetic member.

Optionally, the positioner comprises a bottom plate and a side plate which are arranged in a L-shape, the bottom plate comprising the bottom face, and the side plate comprising the first side face.

Optionally, the positioner further comprises a first guide structure provided on the bottom face; and the first guide structure is configured to guide the positioner when the positioner is moved.

Optionally, the first guide structure is a guide beam provided on the bottom face.

Optionally, the number of the guide beam is at least two and the guide beams are arranged to be parallel to each other.

Optionally, the first side face comprises a bar-shaped protrusion.

Optionally, a side of the bar-shaped protrusion which abuts against the work piece to be positioned is an arc surface.

Optionally, the bar-shaped protrusion extends from the bottom of the first side face to the top of the first side face in a direction perpendicular to the bottom face.

Optionally, the magnetic member comprises a plurality of magnetic bars which are mutually independent.

Optionally, the positioner further comprises a rubber pad attached to the bottom face.

Optionally, the positioner further comprises an opening which is configured to place the positioner on a magnetic platform or to take the positioner away from the magnetic platform.

According to another aspect of the present disclosure, there is provided a positioning equipment comprising a magnetic platform configured for placing a work piece to be positioned, wherein it further comprises a above mentioned positioner, the positioner being adapted to be attracted to the magnetic platform through the magnetic member provided on the bottom face, the first side face being configured to abut against the work piece to be positioned so as to position the work piece to be positioned, the bottom face being provided with a magnetic member.

Optionally, a second guide structure is provide on the magnetic platform, and the positioner further comprises a first guide structure on the bottom face; and wherein the second guide structure is configured to cooperate with the first guide structure provided on the bottom face of the positioner to move the positioner with respect to the magnetic platform in a preset direction.

Optionally, the first guide structure is a guide beam, and the second guide structure is a guide groove.

Optionally, the magnetic platform comprises a bottom plate and at least one side wall provided on the bottom plate, a first side face of the positioner and a side wall of the magnetic platform are configured to abut against the work piece to be positioned, so as to position the work piece to be positioned.

Optionally, the height of the side wall of the magnetic platform is the same as the height of the first side face of the positioner.

### BRIEF DESCRIPTION OF THE DRAWINGS

In order to clearly illustrate the embodiments of the present disclosure or the prior art, the following drawings, which are to be used in the description of the embodiments or the prior art, will be briefly described. It will be apparent that the drawings in the following description are merely a number of embodiments of the present disclosure, and other drawings may be readily conceivable to those ordinary skilled people in the art from these drawings.

FIG. 1(a) is a structural schematic view of a positioner in the prior art.

FIG. 1(b) is a top view of a positioner in the prior art.

FIG. 2(a) is a structural schematic view of a positioner according to an embodiment of the present disclosure.

FIG. 2(b) is another structural schematic view of a positioner according to an embodiment of the present disclosure.

FIG. 2(c) is yet another schematic structural view of a positioner according to an embodiment of the present disclosure.

FIG. 3 is a schematic structural view of a positioner according to an embodiment of the present disclosure which comprises a bottom plate and a side plate.

FIG. 4(a) is a structural schematic view of a positioner according to an embodiment of the present disclosure which comprises a first guide structure.

FIG. 4(b) is another structural schematic view of a positioner according to an embodiment of the present disclosure which comprises a first guide structure.

FIG. 4(c) is yet another structural schematic view of a positioner according to an embodiment of the present disclosure which comprises a first guide structure.

FIG. 4(d) is yet another structural schematic view of a positioner according to an embodiment of the present disclosure which comprises a first guide structure.

FIG. 5(a) is a structural schematic view of a positioner according to an embodiment of the present disclosure, in which the positioner comprises a bar-shaped protrusion on a first side face thereof.

FIG. 5(b) is another structural schematic view of a positioner according to an embodiment of the present disclosure, in which the positioner comprises a bar-shaped protrusion on a first side face thereof.

FIG. 6 is a structural schematic view of a positioner according to an embodiment of the present disclosure, in which the magnetic member of the positioner comprises a plurality of magnetic bars.

FIG. 7 is a structural schematic view of a positioner according to an embodiment of the present disclosure, in which a rubber pad is attached to the bottom face of the positioner.

FIG. 8 is a structural schematic view of a positioner according to an embodiment of the present disclosure, in which the positioner comprises an opening.

FIG. 9 is a structural schematic view of a positioning equipment according to an embodiment of the present disclosure.

FIG. 10 is a structural schematic view of a positioning equipment according to an embodiment of the present disclosure, in which a magnetic platform of the positioning equipment comprises a second guide structure.

FIG. 11 is a structural schematic view of a positioning equipment according to an embodiment of the present disclosure, in which the magnetic platform of the positioning equipment comprises a side wall.

FIG. 12(a) is a structural schematic view of a positioning equipment according to an embodiment of the present disclosure, in which the magnetic platform of the positioning equipment comprises one side wall.

FIG. 12(b) is a structural schematic view of a positioning equipment according to an embodiment of the present disclosure, in which the magnetic platform of the positioning equipment comprises two side walls.

FIG. 12(c) is a structural schematic view of a positioning equipment according to an embodiment of the present disclosure, in which the magnetic platform of the positioning equipment comprises three side walls.

### DETAILED DESCRIPTION OF PREFERRED EMBODIMENTS

The embodiments of the present disclosure will now be described in conjunction with the accompanying drawings in the present disclosure, and it will be apparent that the described embodiments are merely part of the embodiments and not all of the embodiments of the present disclosure. Based on the embodiments of the present disclosure, all other embodiments obtained by those skilled in the art without inventive effort are within the scope of this disclosure.

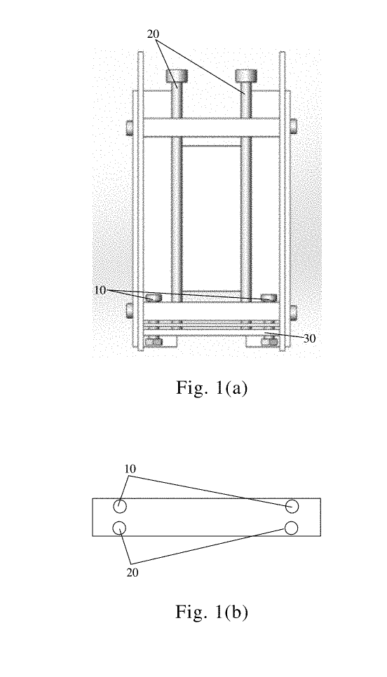

An exemplary positioner is shown in FIG. 1 (a) and FIG. 1 (b). An operation principle thereof is described as follows: after placing a polarizer at a bottom of a stocker, the bottom of the stocker being provided with a groove in which a nut is contained, firstly tightening two first screws 10 with the nut in the groove to secure the positioner at the bottom of the stocker and then threading two second screws 20 against a bottom baffle 30 to press the baffle 30 against the bottom of the stocker, achieving the function of fixing the polarizer.

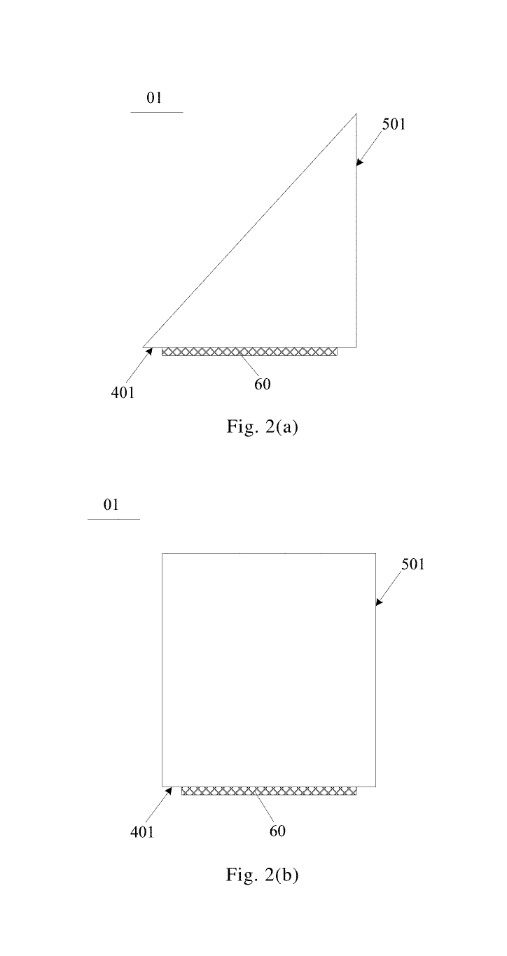

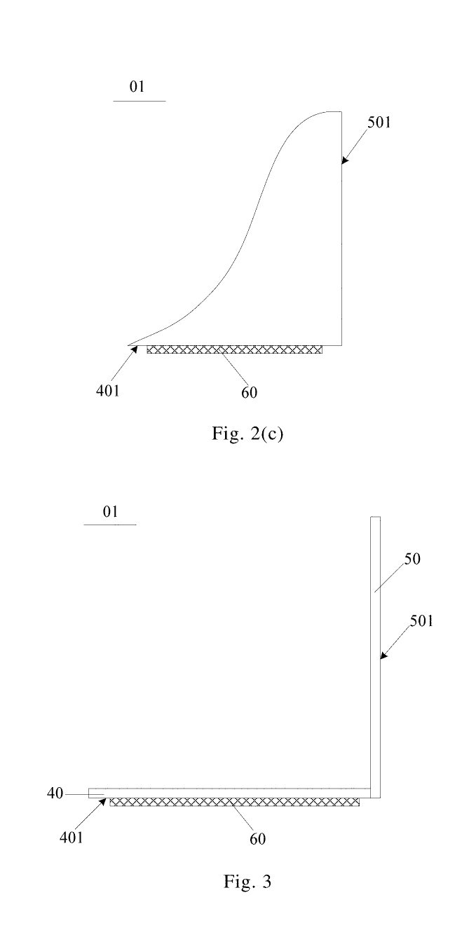

An embodiment of the present disclosure provides a positioner 01, as shown in FIGS. 2 and 3. The positioner 01 includes a bottom face 401 and a first side face 501 which are perpendicular and adjacent to each other. The first side face 501 is configured to abut against the work piece to be positioned so as to position the work piece to be positioned. The bottom face 401 is provided with a magnetic member 60 thereon.

It is to be noted that, firstly, there is no limitation to the shape of the positioner 01, as long as the positioner 01 includes a bottom face 401 and a first side face 501 which are perpendicular and adjacent to each other. The positioner 01 may further include one or more faces in addition to the bottom face 401 and the first side face 501. There is no limitation to shapes of the other faces of the positioner 01 and the relationship between the other faces with the bottom face 401 and the first side face 501. By way of example, the positioner 01 may be shaped as a right-angled triangular prism as shown in FIG. 2 (a), or may be shaped as a cube as shown in FIG. 2 (b); of course, it may be irregularly shaped as shown in FIG. 2 (c) which comprises the bottom face 401 and first side face 501 perpendicular and adjacent to each other.

Secondly, the magnetic member 60 may be provided on an outer side of the bottom face 401 or may be provided on an inner side of the bottom face 401. Here, the positioner 01 may be placed on a magnetic platform with a magnetic adsorption therebetween, thereby positioning the work piece to be positioned which is placed on the magnetic platform. Since a distance between the magnetic member 60 and the magnetic platform is minimized and an adsorption force between the magnetic member 60 and the magnetic platform is the maximized when the magnetic member 60 is disposed on the outer side of the bottom face 401, the magnetic member 60 may be optionally provided on the outer side of the bottom face 401

Here, it is possible that the magnetic member 60 itself has a magnetic adsorption capacity or the magnetic member 60 includes a magnetic substance. By way of example, when the positioner 01 perform an positioning operation on the work piece placed on the magnetic platform; if the magnetic platform comprises ferromagnetic materials such as iron, cobalt, nickel, ferrite, the magnetic member 60 comprises a magnet; if the magnetic platform comprise a magnet, the magnetic member 60 comprises ferromagnetic materials such as iron, cobalt, nickel, ferrite. On such a basis, the magnetic member 60 may be a pure magnet, or the magnetic member 60 may include a magnet and other substances; or the magnetic member 60 may be completely made of ferromagnetic materials such as iron, cobalt, nickel, ferrite, it is also possible that the magnetic member 60 includes a ferromagnetic material such as iron, cobalt, nickel or ferrite and other non-ferromagnetic materials. There is no specific limitation thereto, but it should be ensured that the magnetic member 60 may cause the positioner 01 and the magnetic platform to be adsorbed to each other.

In addition, it is possible that the magnetic member 60 is unitary or a plurality of mutually independent sub-magnetic members.

Thirdly, there is no limitation to the work piece to be positioned. For example, the work piece to be positioned may be a polarizer, a diffusion sheet, or a light guide plate in a display device, which may be positioned by the positioner 01 according to the embodiment of the present disclosure.

The positioner 01 may position one work piece to be positioned or a plurality of laminated work pieces to be positioned which are of the same size and shape.

Fourthly, there is no limitation to the material of the positioner 01. For example, a metal material such as aluminum or an aluminum alloy may be used.

A positioner is provided by the embodiments of the present disclosure. When the positioner 1 performs a positioning operation on the work piece placed on the magnetic platform, as the bottom face 401 of the positioner 01 is provided with a magnetic member 60 which allows the positioner 01 to be adsorbed onto the magnetic platform. Further, when the first side face 501 of the positioner 01 is abutted against the work piece to be positioned, the work piece to be positioned may be positioned by the positioner 01. The positioner 01 in the prior art includes four screws, while the positioner 01 according to the present disclosure has a simpler structure. Further, when performing the positioning operation, it is only necessary to abut the first side face thereof against the work piece to be positioned, such that the positioning process is easier. On such a basis, it is necessary to thread the screws of the positioner 01 in the prior art when performing a positioning operation, which leads to screw slippage or deformation, resulting in a tilt of screws, and then resulting a damage to an edge of the work piece to be positioned when the work piece is taken out. On the other hand, the bottom face 401 and the first side face 501 of the positioner 01 provided by the embodiment of the present disclosure are kept perpendicular to each other, so that it is possible to prevent the work piece to be positioned from being damaged when the work piece to be positioned is removed.

Optionally, as shown in FIG. 3, the positioner 01 includes a bottom plate 40 and a side plate 50 which are arranged in a L-shape. The bottom plate 40 comprises the bottom face 401, and the side plate 50 comprises the first side face 501.

The magnetic member 60 may be provided on the lower surface of the bottom plate 40 or may be provided on the upper surface of the bottom plate 40, and of course may be provided in the bottom plate 40. Wherever the magnetic member 60 is provided at the bottom plate 40, it should be ensured that the magnetic member 60 may cause the positioner 01 and the magnetic platform to be adsorbed to each other.

Here, the bottom plate 40 and the side plate 50 may be integrally molded to simplify the manufacturing process of the positioner 01.

In an embodiment of the present disclosure, after the magnetic member 60 causes the positioner 01 and the magnetic platform to be adsorbed together, positioning to the work piece to be positioned may be achieved by abutting the first side face 501 against the work piece to be positioned, as long as the positioner 01 includes the bottom face 401 and the first side face 501 which are perpendicular and adjacent to each other. On the other hand, when the positioner 01 includes the bottom plate 40 and the side plate 50, not only may the positioning to the work piece to be positioned be achieved, but also may the material required for the positioner 01 be reduced, which simplifies the structure of the positioner 01 and saves the cost of production.

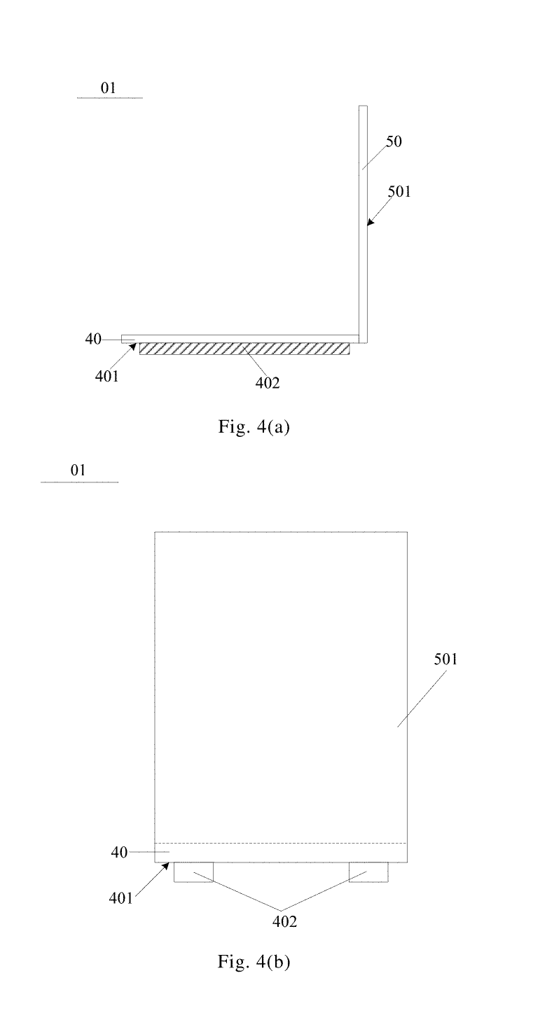

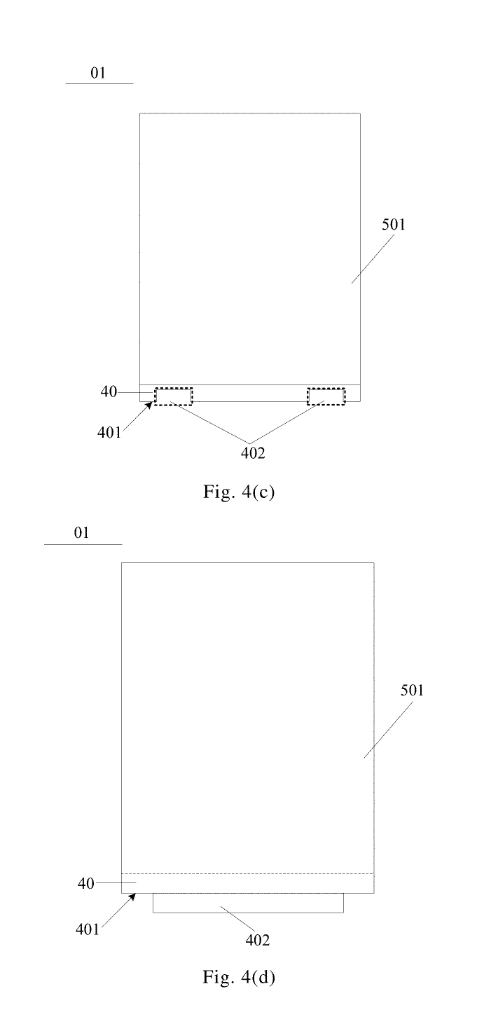

Optionally, as shown in FIGS. 4(a), 4(b), 4(c) and 4(d), the positioner 01 further includes a first guide structure 402 which is provided on the bottom face 401 thereof, and configured to guide the positioner 01 when the positioner is moved.

There is no limitation to the specific structure of the first guide structure 402, as long as the first guide structure 402 is able to guide the positioner 01 when the positioner 01 is moved. Here, the first guide structure 402 cooperates with the guide structure on the magnetic platform so as to move the positioner 01 in a preset direction. For example, the first guide structure 402 may be a guide beam provided on the bottom face 401 as shown in FIGS. 4 (a), 4 (b) and 4 (d), and the magnetic platform is provided with a guide groove, or the first guide structure 402 may also be a guide groove provided on the bottom face 401 as shown in FIG. 4 (c), while a guide beam is provided on the magnetic platform.

It should be noted that, the bottom plate 40, the side plate 50 and the first guide structure 402 may be integrally molded to simplify the manufacturing process of the positioner 01 in case that the positioner 01 includes the bottom plate 40, the side plate 50 and the first guide structure 402.

In an embodiment of the present disclosure, the first guide structure 402 is provided on the bottom face 401 of the positioner 01, so that the first guide structure 402 cooperates with the second guide structure on the magnetic platform, such that the positioner 01 may be moved on the magnetic platform in the preset direction, which prevents the direction of the positioner 01 from being changed during the movement of the positioner 01 and ensures that the first side face 501 of the positioner 01 is abutted against the work piece to be positioned.

Optionally, as shown in FIGS. 4(a), 4(b) and 4(d), the first guide structure 402 is a guide beam provided on the bottom face 401.

There is no limitation to the number of guide beams provided on the bottom face 401, as long as the positioner 01 may be smoothly moved on the magnetic platform. For example, it is possible that, as shown in FIG. 4 (b), two guide beams may be provided on the bottom face 401 or as shown in FIG. 4 (d), one guide beam may be provided on the bottom face 401. In case that one guide beam is provided on the bottom face 401, the position and size of the guide beam should be appropriately set so that the positioner 01 may smoothly move on the magnetic platform.

If the first guide structure 402 is a guide groove, in order to engage the first guide structure 402 with the second guide structure on the magnetic platform to move the positioner 01 in the preset direction, the guide beam should be provided on the magnetic platform which is engaged with the guide groove. On the other hand, if the guide beam is provided on the magnetic platform, the guide beam will contact and support the work piece to be positioned when the work piece is placed on the magnetic platform, it is thus possible that the work piece to be positioned is not stable, which is harmful for an accurate positioning of the work piece to be positioned. On such a basis, one option is that the first guide structure 402 is a guide beam provided on the bottom face 401.

Further as shown in FIG. 4(b), the number of the guide beams is at least two and they are arranged parallel to each other.

In the embodiment of the present disclosure, two or more guide beams are provided on the bottom face 401 and are parallel to each other. Compared with the case that only one guide beam is provided on the bottom face 401, the configuration of two or more guide beams may ensure that the positioner 01 may smoothly move on the magnetic platform.

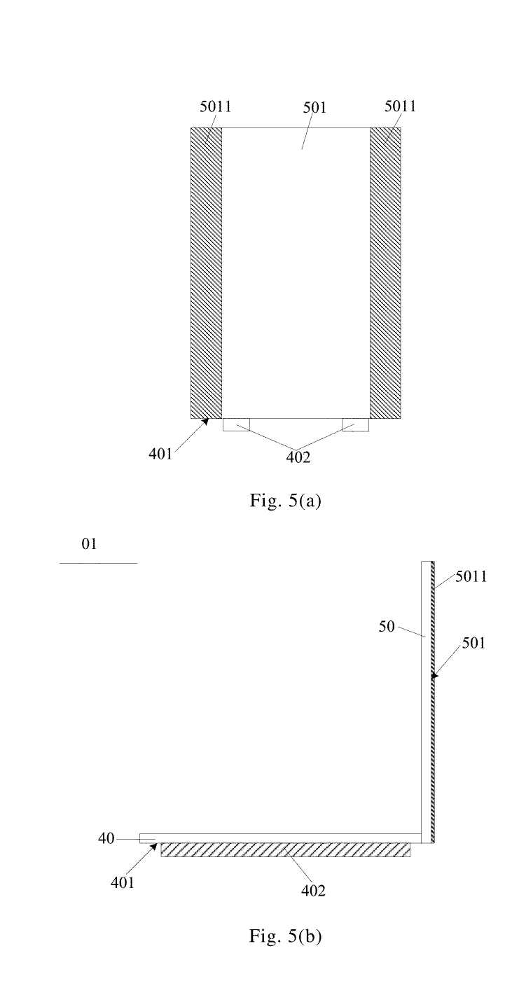

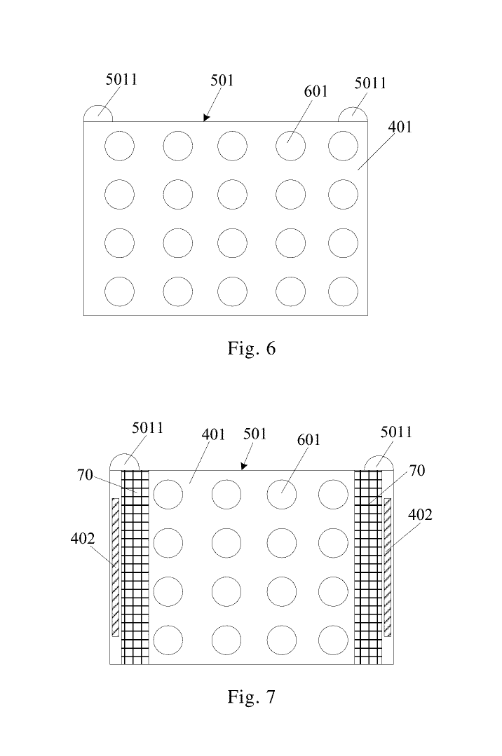

Optionally, as shown in FIGS. 5(a), 5 (b) and 6, the first side face 501 includes a bar-shaped protrusion 5011.

It should be noted that it is illustrated in FIG. 5 (b) that the positioner 01 includes a bottom plate 401 and a side plate 501 as an example, but the positioner 01 is not limited to this configuration.

There is no limitation to the shape of the bar-shaped protrusion 5011, and a side of the bar-shaped protrusion 5011 near the work piece to be positioned may be a planar face or a circular arc face. In addition, there is no limitation to the number of the bar-shaped protrusions 5011 included in the first side face 501. The first side face 501 may include one bar-shaped protrusion 5011, or two or more bar-shaped protrusions 5011. The length of the bar-shaped protrusion 5011 may be less than or equal to the height of the first side face 501 in a direction perpendicular to the bottom face 401.

On such a basis, there is no limitation to the angle between the intersection lines of the bar-shaped protrusions 5011 with the bottom face 401 and the first side surface 501. It may be provided perpendicularly or obliquely. It is illustrated in FIGS. 5 (a) and 5 (b) that the angle between the intersection lines of the bar-shaped protrusions 5011 with the bottom face 401 and the first side surface 501 is a right angle as an example.

In an embodiment of the present disclosure, the first side face 501 includes a bar-shaped protrusion 5011 such that a contact area of the work piece to be positioned and the first side face 501 of the retainer 01 is reduced when the work piece to be positioned is positioned by the positioner. In case that the work piece is removed after it is positioned by the positioner, as the contact area between the work piece to be positioned and the first side face 501 of the positioner 01 is reduced, the risk of damaging to the work piece to be positioned will be reduced.

Further optionally, as shown in FIG. 6, the side of the bar-shaped protrusion 5011 abutting against the work piece to be positioned is a circular arc face.

In case that the side of the bar-shaped protrusion 5011 which abuts against the work piece to be positioned is a circular arc surface, the work piece to be positioned is in line contact with the bar-shaped protrusion 5011, then the contact area between the bar-shaped protrusion 5011 and the work piece to be positioned is minimized, so that it is possible to further reduce the risk of the damage to the work piece to be positioned when the work piece to be positioned is removed.

Optionally, as shown in FIGS. 5(a) and 5(b), the bar-shaped protrusions 5011 extend from one side of the first side face 501 to the other side of the first side face 501 along the direction perpendicular to the bottom face 401.

If the length of the bar-shaped protrusion 5011 is the same as the height of the first side face 501 in the direction perpendicular to the bottom face 401, the number of the work piece to be positioned by the positioner 01 is maximized. On such a basis, the length of the bar-shaped protrusion 5011 is minimized when the bar-shaped protrusion 5011 is perpendicular to the intersection of the bottom face 401 and the first side face 501. Therefore, in case that the bar-shaped protrusion 5011 extends from one side of the side face 501 to the other side of the side face 501 in the direction perpendicular to the bottom face 401, not only may the number of the work piece to be positioned by the positioner 01 be maximized, but also may the material required to produce the bar-shaped protrusions 5011 be minimized and the production cost will be saved.

Optionally, as shown in FIG. 6, the magnetic member 60 includes a plurality of mutually independent magnetic bars 601.

In the case that the area for arranging the magnetic member 60 on the bottom surface 401 is the same, compared with the arrangement that the magnetic member 60 is in a single block, the magnetic member 60 of the present disclosure includes a plurality of mutually independent magnetic bars 601, reducing the area of the bottom face 401 occupied by the magnetic member 60, then reducing the adsorption force of the magnetic member 60 to the magnetic platform, facilitating removal of the positioner 01 from the magnetic platform.

Optionally, as shown in FIG. 7, the positioner 01 further includes a rubber pad 70 attached to the bottom face 401.

It will be appreciated by those skilled in the art that, if the magnetic member 60 is disposed on the outside of the bottom face 401, the thickness of the rubber pad 70 should be greater than or equal to the thickness of the magnetic member 60 to ensure that the rubber pad 70 may be brought into contact with the magnetic platform 70; if the magnetic member 60 is disposed on the inner side of the bottom face 401, a rubber pad 70 may be provided on the outer side of the bottom face 401. In addition, in case that the first guide structure 402 is provided on the bottom surface 401, the first guide structure 402 and the rubber pad 70 should not be overlapped.

In the embodiment of the present disclosure, the rubber pad 70 is attached to the bottom face 401 of the positioner 01 to increase a frictional force between the positioner 01 and the magnetic platform so as to prevent the positioner 01 from moving after it performs a position operation to the work piece to be positioned. Therefore, the positioner 01 is fixed tightly onto the magnetic platform, improving the stability of the positioner 01, and has a good positioning function.

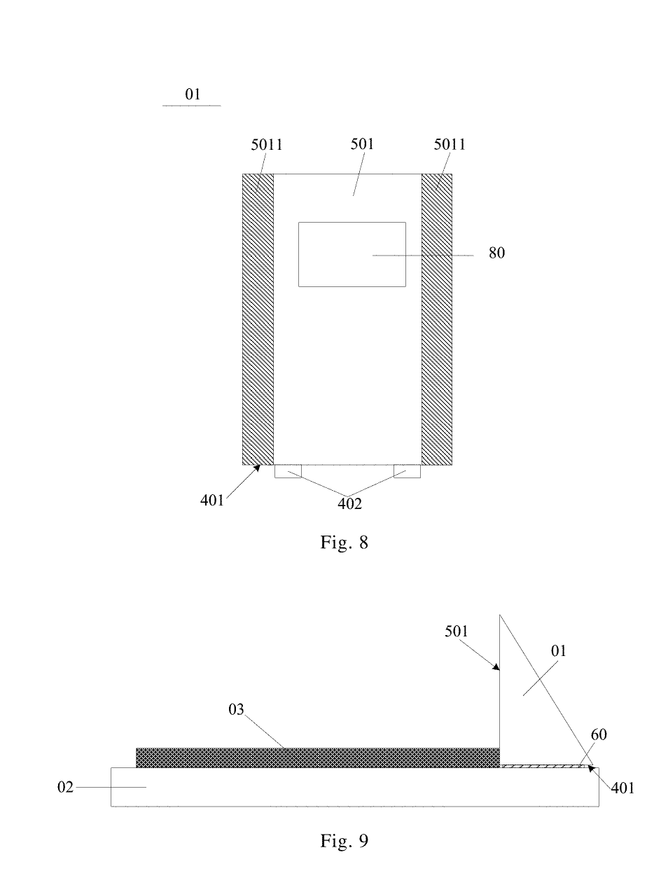

Optionally, as shown in FIG. 8, the positioner 01 includes an opening 80 which is configured to place the positioner 01 on a magnetic platform or take the positioner 01 away from the magnetic platform.

The opening 80 may be provided on the first side face 501 as shown in FIG. 8, or may be provided on any faces of the positioner 01 other than the bottom face 401. Here, the opening 80 should be sized such that it is accessible by human hands to facilitate placing the positioner or removing the same.

In the embodiment of the present disclosure, the opening 80 is provided on the positioner 01 so that the positioner 01 may be easily removed or placed when the work piece to be positioned is positioned by the positioner 01.

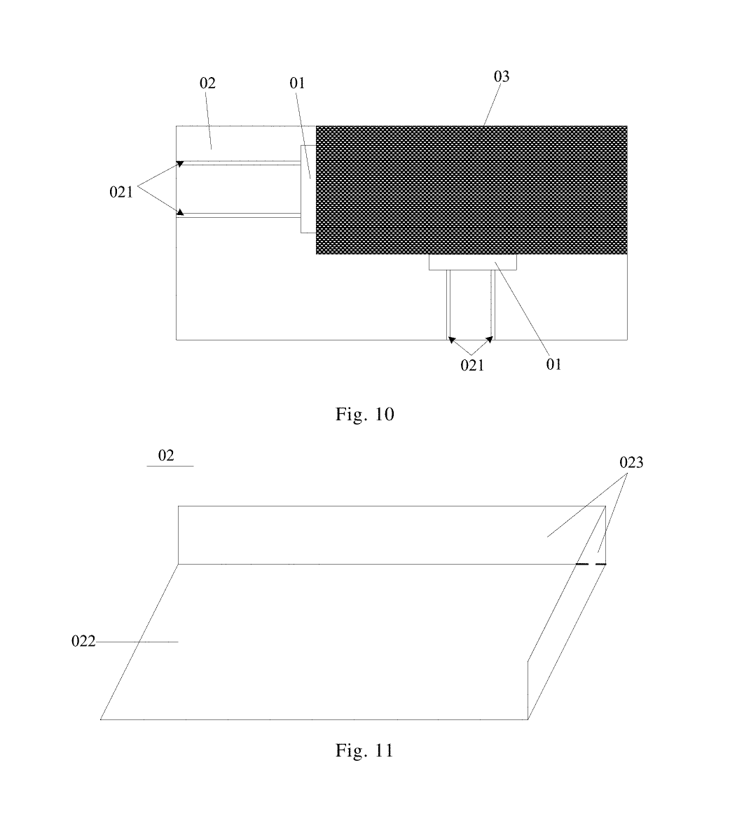

The embodiment of the present disclosure also provides a positioning equipment, as shown in FIG. 9, including a magnetic platform 02 for placing the work piece to be positioned 03, and the above-mentioned positioner 01 being adapted to be adsorbed to the magnetic platform 02 through the magnetic member 60 provided on the bottom face 401, the first side face 501 being configured to abut against the work piece to be positioned 03 so as to position the work piece to be positioned 03.

The positioning process of the positioning equipment to the work piece to be positioned 02 is described as follows: firstly removing the positioner 01 from the positioning equipment, and then placing the work piece to be positioned 03 onto the magnetic platform 02 as required. After the work piece to be positioned 03 is placed, placing the positioner 01 onto the magnetic platform 02 and moving the positioner 01 so that the first side face 501 of the positioner 01 abuts against the work piece to be positioned 03. Since the magnetic member 60 on the bottom face 401 of the positioner 01 allows the positioner 01 to be adsorbed onto the magnetic platform 02, the positioner 01 is tightly fixed onto the magnetic platform 02 so that the work piece 03 may be positioned.

Here, when the positioning equipment is used to position the work piece to be positioned, the number of the positioners 01 should be appropriately set as necessary. For example, in case that the work piece to be positioned 03 is rectangular, if the four sides of the work piece to be positioned 03 are not fixed, at least one positioner 01 may be provided respectively on each one of the four sides of the work piece to be positioned 03. If one side of the work piece to be positioned 03 is fixed, at least one positioner 01 may be provided on each of the rest three sides of the work piece to be positioned 03, and so on, and will not be described in detail here.

Here, the positioner 01 is placed on the magnetic platform 02, and the magnetic member 60 may be in contact with the magnetic platform 02 or may not be in contact with the magnetic platform 02, as long as the magnetic member 60 may cause the positioner 01 to be attracted on the magnetic platform 02.

In an embodiment of the present disclosure, there is provides a positioning equipment. As the positioning equipment comprises a magnetic platform 2, the positioner 01 may be attracted onto the magnetic platform 02 through the magnetic member 60 provided on the bottom face 401 when the positioner 01 is placed onto the magnetic platform 02, so that the positioner 01 may be fixed onto the magnetic platform 02. On such a basis, when the work piece to be positioned 03 is placed on the magnetic platform 02, and the first side face 501 of the positioner 01 is abutted against the work piece to be positioned 03, the work piece to be positioned 03 may be positioned by the positioner 01. The positioner 01 in the prior art includes four screws, while the positioner 01 according to the present disclosure has a simpler structure. Further, when performing the positioning operation, it is only necessary to abut the first side face against the work piece to be positioned, such that the positioning process is easier. On such a basis, it is necessary to thread the screws of the positioner 01 in the prior art when performing a positioning operation, which leads to screw slippage or deformation, resulting in a tilt of screws, and then resulting damage to an edge of the work piece to be positioned when the work piece is taken out. On the other hand, the bottom face 401 and the first side face 501 of the positioner 01 provided by the embodiment of the present disclosure are kept perpendicular to each other, so that it is possible to prevent the work piece to be positioned from being damaged when the work piece to be positioned is removed.

Optionally, as shown in FIG. 10, the second guide structure 021 is provided on the magnetic platform 02, and the positioner 01 further includes a first guide structure 402 provided on the bottom face 401. The second guide structure 021 cooperates with the first guide structure 402 disposed on the bottom face 401 of the positioner 01 so that the positioner 01 is moved in the preset direction with respect to the magnetic platform 02.

There is no limitation to the specific structure of the first guide structure 402 and the second guide structure 021, as long as the first guide structure 402 and the second guide structure 021 may be engaged so that the positioner 01 is moved in the preset direction with respect to the magnetic stage 02. For example, the first guide structure 402 may be a guide beam provided on the bottom face 401, while the second guide structure 021 may be a guide groove provided on the magnetic platform 02; or the first guide structure 402 may be a groove provided on the bottom face 401, while the second guide structure 021 may be a guide beam provided on the magnetic platform 02.

In the embodiment of the present disclosure, the second guide structure 021 is provided on the magnetic platform 02 and the second guide structure 021 cooperates with the first guide structure 402 so that the positioner 01 may move in the preset direction on the magnetic platform 02, preventing the direction of the positioner 01 from changed during the movement of the positioner 01, and ensuring that the first side face 501 of the positioner 01 is abutted against the work piece to be positioned.

Optionally, the first guide structure 402 is a guide beam and the second guide structure 021 is a guide groove.

When the first guide structure 402 is the guide beam and the second guide structure 021 is the guide groove, the first guide structure 402 and the second guide structure 021 may be engaged to move the positioner 01 along the guide groove. Finally the first side face 501 of the positioner 01 is brought into contact with the work piece to be positioned 03 and position the work piece to be positioned 03.

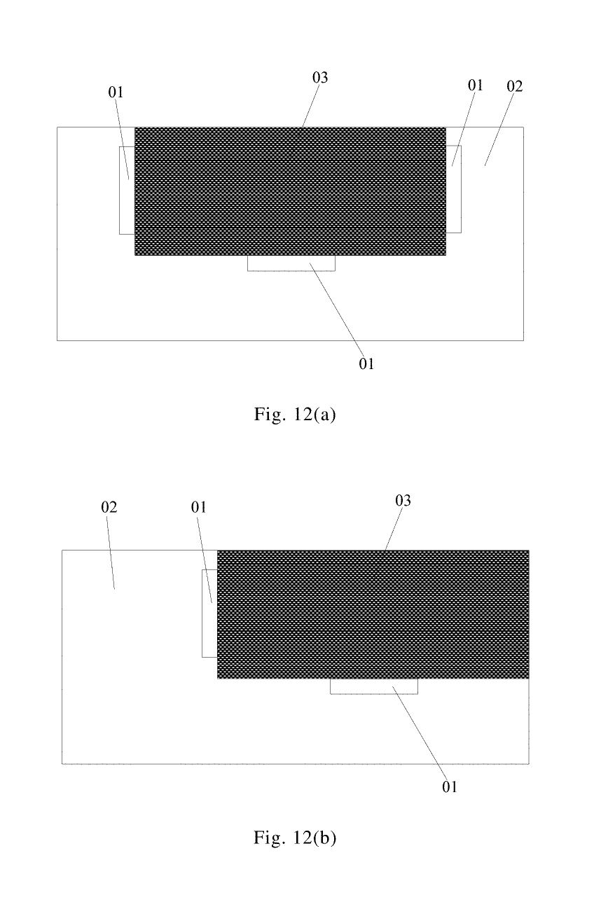

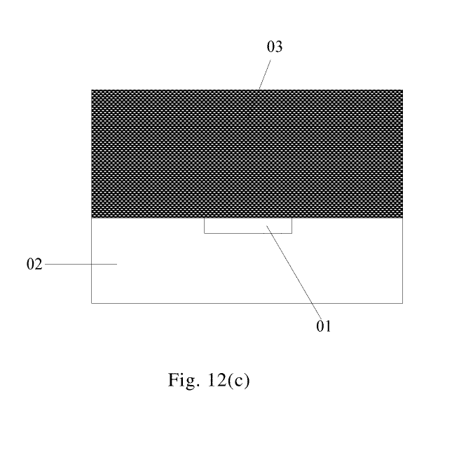

Optionally, as shown in FIGS. 11 and 12, the magnetic platform 02 includes a bottom plate 022 and at least one side wall 023 provided on the bottom plate 022. The first side face 501 of the positioner 01 and the side wall 023 of the magnetic platform 02 serve to abut against the work piece to be positioned 03 so as to position the work piece to be positioned 03.

The magnetic platform 02 may include one side wall 023, or may include two or three side walls 023. There is no limitation thereto.

It should be noted that, as shown in FIG. 12 (a), if the magnetic platform 02 includes one side wall 023, one side of the work piece to be positioned 03 may abut against one side wall 023 of the magnetic platform 02 when the work piece to be positioned 03 is placed. Therefore, at least three positioners 01 are required to position the work piece to be positioned 03 when positioning the work piece to be positioned 03. The first side face 501 of each positioner 01 abuts against the work piece to be positioned 03. As shown in FIG. 12 (b), if the magnetic platform 02 includes two side walls 023, two sides of the work piece to be positioned 03 are abutted against two side walls 023 of the magnetic platform 02, respectively, when the work piece to be positioned 03 is placed. Therefore, at least two positioners 01 are required to position the work piece to be positioned 03 when positioning the work piece to be positioned 03. The first side face 501 of each positioner 01 abuts against the work piece to be positioned 03. As shown in FIG. 12 (c), if the magnetic platform 02 includes three side walls 023, and the distance between two opposite side walls 023 of the three side walls 023 is the same as the length or width of the work piece to be positioned 03, three sides of the work piece to be positioned 03 are abutted against three side walls 023 of the magnetic platform 02, respectively, when the work piece to be positioned 03 is placed. Therefore, at least one positioner 01 is required to position the work piece to be positioned 03 when positioning the work piece to be positioned 03. The first side face 501 of the positioner 01 abuts against the work piece to be positioned 03. It should be noted that if the magnetic platform 02 includes three side walls 023, it is easy to damage the work piece to be positioned 03 when the work piece to be positioned 03 is placed on the magnetic platform 02. Therefore, one option is that the magnetic platform 02 comprises one or two side walls 023.

In the embodiment of the present disclosure, since the magnetic platform 02 includes a side wall 023, the work piece to be positioned 03 may be positioned by combination of the side wall 023 and the positioner 01, so that the number of the positioners 01 required in the positioning process to the work piece to be positioned 03 will be reduced.

Optionally, the height of the side wall 023 of the magnetic platform 02 is the same as the height of the first side face 501 of the positioner 01.

In the embodiment of the present disclosure, the height of the side wall 023 of the magnetic platform 02 is the same as the height of the first side face 501 of the positioner 01, so that the thickness of the plurality of work piece to be positioned 03 by combination of the side wall 023 and the positioner 01 is the same as the height of the side wall 023 of the magnetic platform 02 or the height of the first side face 501 of the positioner 01. Therefore, the number of the work piece to be positioned 03 may be maximized.

Above described are only some specific embodiments of the present disclosure, although the protect scope of the present disclosure is not limited thereto. Those skilled in the art will readily conceive modifications or alternative within the technical scope in this disclosure. Accordingly, the protection scope of the present disclosure should be defined by the claims and their equivalents.

What is claimed is:

1. A positioner comprising a bottom face and a first side face which are perpendicular and adjacent to each other, the first side face being configured to abut against a work piece to be positioned so as to position the work piece to be positioned, the bottom face being provided with a magnetic member.

2. The positioner according to claim 1, wherein the positioner comprises a bottom plate and a side plate which are arranged in an L-shape, the bottom plate comprising the bottom face, and the side plate comprising the first side face.

3. The positioner according to claim 1, wherein the positioner further comprises a first guide structure on the bottom face; and
the first guide structure is configured to guide the positioner when the positioner is moved.

4. The positioner according to claim 3, wherein the first guide structure is a guide beam on the bottom face.

5. The positioner according to claim 4, wherein the number of the guide beam is at least two and the guide beams are arranged to be parallel to each other.

6. The positioner according to claim 1, wherein the first side face comprises a bar-shaped protrusion.

7. The positioner according to claim 6, wherein a side of the bar-shaped protrusion which abuts against the work piece to be positioned is an arc surface.

8. The positioner according to claim 6, wherein the bar-shaped protrusion extends from the bottom of the first side face to the top of the first side face in a direction perpendicular to the bottom face.

9. The positioner according to claim 1, wherein the magnetic member comprises a plurality of magnetic bars which are mutually independent.

10. The positioner according to claim 1, wherein the positioner further comprises a rubber pad attached to the bottom face.

11. The positioner according to claim 1, wherein the positioner further comprises an opening which is configured to place the positioner on a magnetic platform or to take the positioner away from the magnetic platform.

12. A positioning equipment comprising:
a magnetic platform configured for placing a work piece to be positioned; and
a positioner according to claim 1;
the positioner being adapted to be attracted to the magnetic platform through the magnetic member provided on the bottom face, the first side face being configured to abut against the work piece to be positioned so as to position the work piece to be positioned.

13. The positioning equipment according to claim 12, wherein a second guide structure is provided on the magnetic platform, and the positioner further comprises a first guide structure on the bottom face; and wherein the second guide structure is configured to cooperate with the first guide structure provided on the bottom face of the positioner to move the positioner with respect to the magnetic platform in a preset direction.

14. The positioning equipment according to claim 13, wherein the first guide structure is a guide beam, and the second guide structure is a guide groove.

15. The positioning equipment according to claim 12, wherein the magnetic platform comprises a bottom plate and at least one side wall provided on the bottom plate, and a first side of the positioner and a side wall of the magnetic platform are configured to abut against the work piece to be positioned, so as to position the work piece to be positioned.

16. The positioning equipment according to claim 15, wherein a height of the side wall of the magnetic platform is the same as a height of the first side of the positioner.

17. The positioner according to claim 2, further comprising a first guide structure on the bottom face; and
the first guide structure is configured to guide the positioner as the positioner is moved.
